(19) United States
(12) Patent Application Publication
(10) Pub. No.: US 2002/0015310 A1
(43) Pub. Date: Feb. 7, 2002

(54) Vehicle structural assembly with integrally formed lamp housing

(76) Inventor: Michael F. Pickholz, Oxford, MI (US)

Correspondence Address: HARNESS, DICKEY & PIERCE, PLC, P.O. BOX 828, BLOOMFIELD HILLS, MI, 48303, US

(21) Appl. No.: 09/792,868

(22) Filed: Feb. 23, 2001

Related U.S. Application Data
(60) Provisional application No. 60/184,302, filed on Feb. 23, 2000.

(51) Int. Cl. B60Q 1/00

(52) U.S. Cl. 362/487

(57) ABSTRACT

A vehicle structural assembly includes a main body portion defining first and second lamp housings. Each of the lamp housings including a lower wall, an inboard wall, an outboard wall and a rear wall. The rear wall is stepped to include first and second portions each defining a cylindrical opening. The lower, inboard, outboard and rear walls defining a lamp aperture. The vehicle structural assembly further includes first and second lamp assemblies disposed in the lamp apertures defined by the first and second lamp housings, respectively. Both of the lamp assemblies include a lamp module and a lens.

### BACKGROUND OF THE INVENTION

1. Technical Field

The present invention generally pertains to motor vehicles. More particular, the present invention pertains to a vehicle structural assembly including an integrally formed lamp housing.

2. Discussion

It is customary to provide a vehicle panel such as a front fascia with a portion including a plurality of orthogonally oriented walls which cooperate to define an opening for receiving an encapsulated lamp. Heretofore, most such encapsulated lamps were externally aimed. Modernly, such encapsulated lamps are internally aimed. The present invention desires to eliminate the need for a separate lamp housing, effectively incorporating the lamp housing into the body panel.

Completion of the walls for such an integrally formed lamp housing results in negligible costs. Further, this would allow for the elimination of a conventional mounting bracket and/or mounting flanges, access holes, and fasteners. Other advantages include, but are not limited to weight reduction, lower lamp tooling costs, less assembly time, and less tolerance stack up.

### SUMMARY OF THE INVENTION

It is a general object of the present invention to provide a motor vehicle structural member including an integrally formed lamp housing.

It is another object of the present invention to provide a motor vehicle structural assembly which reduces the amount of brackets and fasteners conventionally required for mounting of lamps to the motor vehicle.

In one form, the present invention provides a vehicle structural assembly includes a main body portion defining first and second lamp housings. Each of the lamp housings including a lower wall, an inboard wall, an outboard wall and a rear wall. The rear wall is stepped to include first and second portions each defining a cylindrical opening. The lower, inboard, outboard and rear walls defining a lamp aperture. The vehicle structural assembly further includes first and second lamp assemblies disposed in the lamp apertures defined by the first and second lamp housings, respectively. Both of the lamp assemblies include a lamp module and a lens.

Additional benefits and advantages of the present invention will become apparent to those skilled in the art to which this invention relates from a reading of the subsequent description of the preferred embodiments, taken in conjunction with the accompanying drawings.

### BRIEF DESCRIPTION OF THE DRAWINGS

FIG. 1 is a perspective view of a front end module of a motor vehicle constructed in accordance with the teachings of a first preferred embodiment of the present invention to integrally include a pair of lamp housing.

FIG. 2 is an enlarged perspective view of a portion of the front end module of FIG. 1.

FIG. 3 is a perspective view similar to FIG. 2, illustrating the front end module including a lamp module and lens.

FIG. 4 is a perspective view similar to FIG. 3, shown with the lens removed for purposes of illustration.

FIG. 5 is a perspective view of a front fascia assembly constructed in accordance with the teachings of a second preferred embodiment of the present invention.

FIG. 6 is a perspective view of the head lamp mounting module of FIG. 5, removed from the remainder of the front fascia assembly for purposes of illustration.

FIG. 7 is an exploded view of the head lamp component of FIG. 5.

FIG. 8 is an exploded perspective view of a rear fascia assembly constructed in accordance with the teachings of a third preferred embodiment of the present invention.

### DETAILED DESCRIPTION OF THE PREFERRED EMBODIMENTS

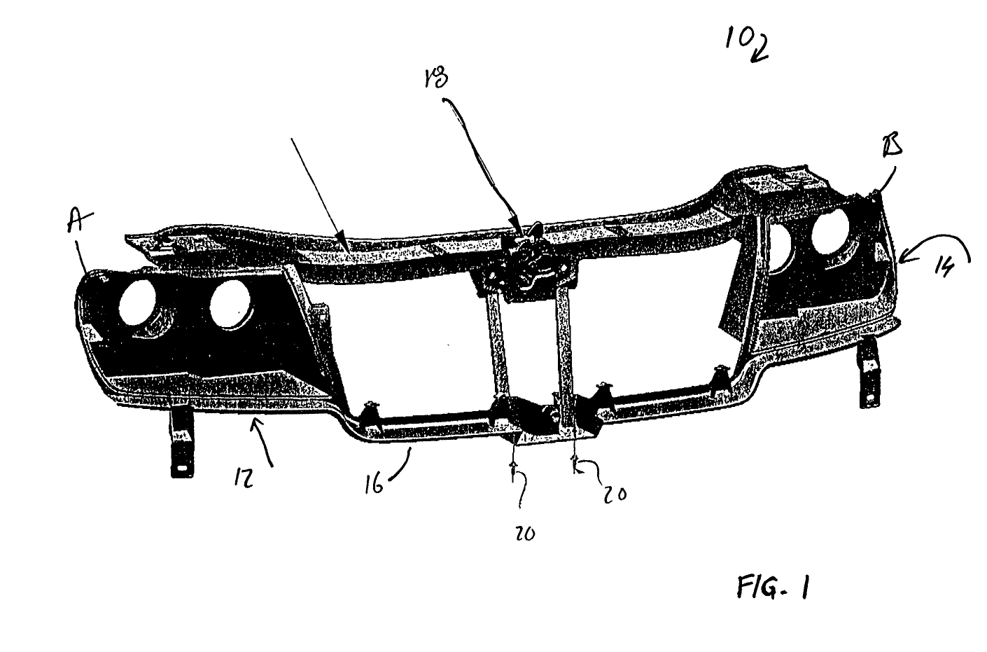

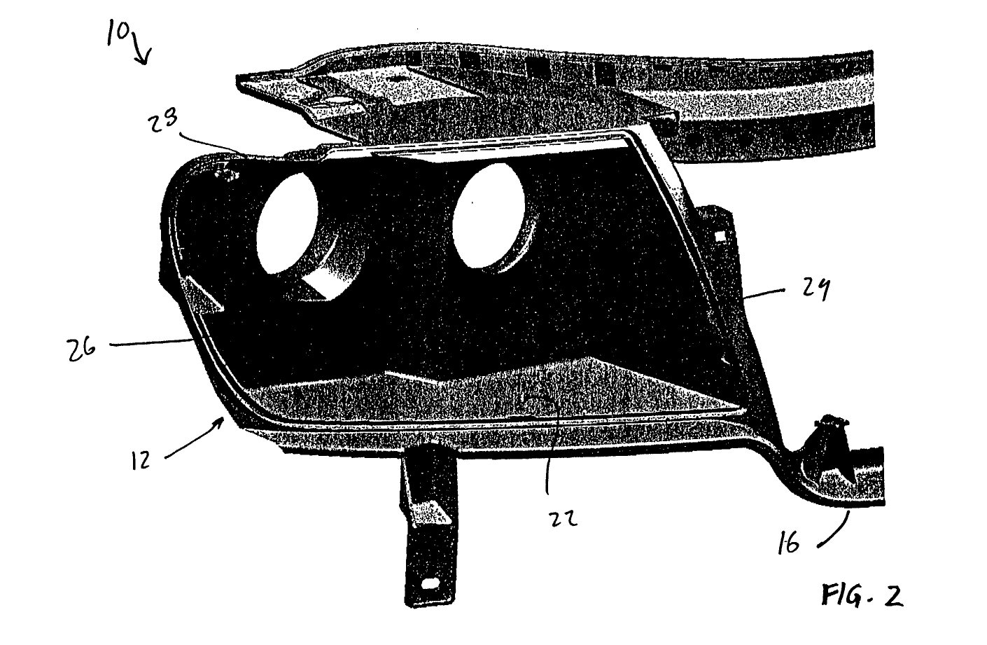

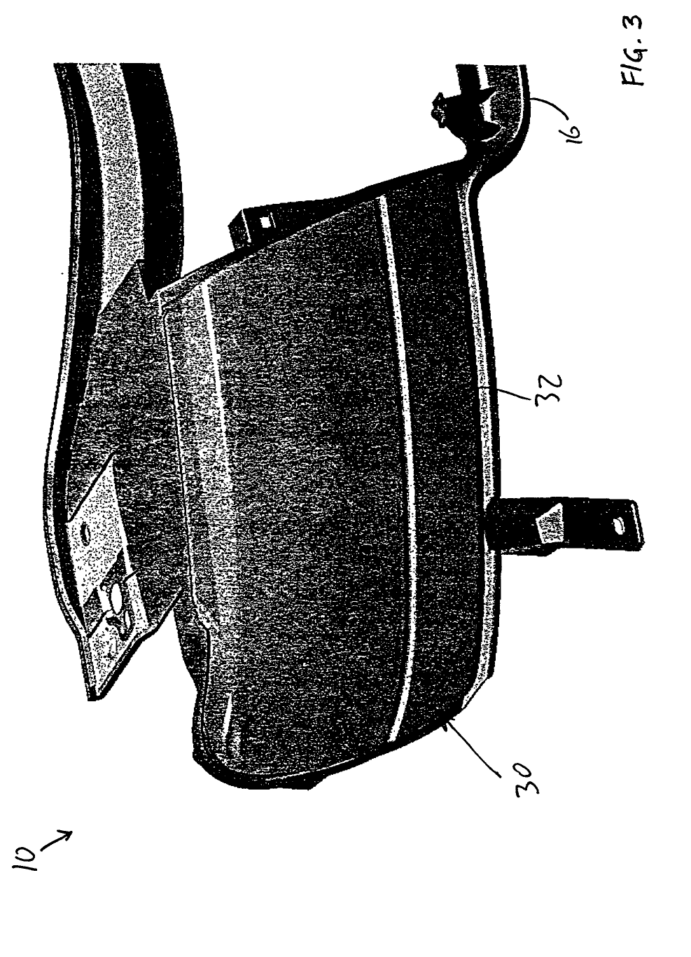

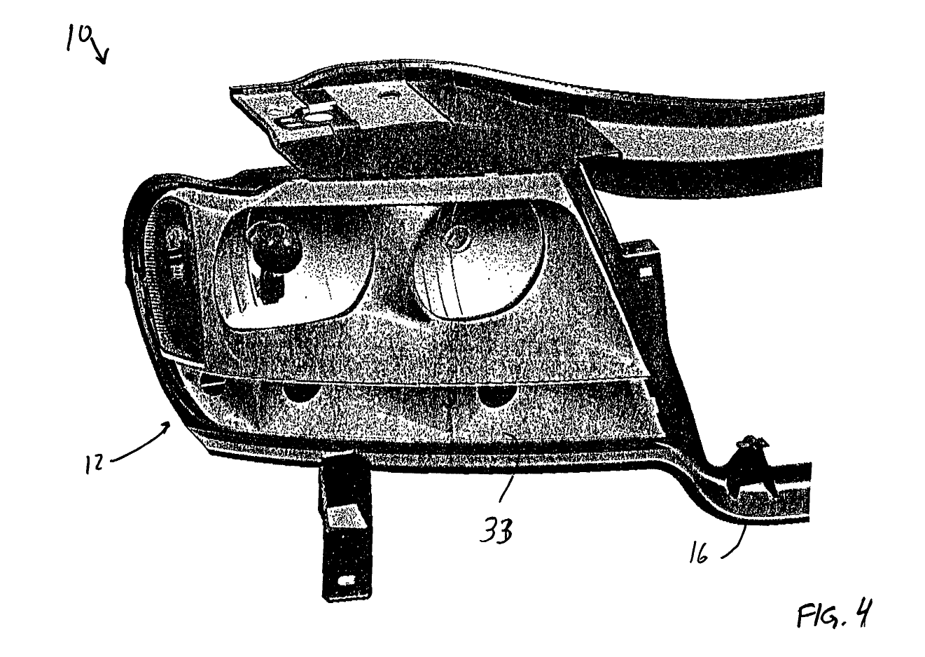

With initial reference to FIG. 1 through 4, a first preferred embodiment of the present invention will be described. A structural assembly of a motor vehicle constructed in accordance with the teachings of a preferred embodiment of the present invention is illustrated and generally identified at reference numeral 10. The structural assembly 10 is illustrated in the first preferred embodiment of the present invention as a front end assembly for a motor vehicle. However, it will be understood by those skilled in the art that the teachings of the present invention are not limited to any particular assembly.

In the exemplary embodiment illustrated, the structural assembly is a front end assembly 10 defining first and second lamp housing or cans 12 and 14. It will be understood that the assembly 10 is a substantial mirror image about a vertical centerline. The assembly 10 primarily consists of a main body portion 16 which is unitarily formed of plastic through injection molding. Hybrid materials may be incorporated in a manner known in the art for purposes of reinforcement. In FIG. 1, the assembly 10 is further illustrated to include a hood latch assembly 18 and a pair of screws 20 for securing the assembly 10 to a bumper beam (not shown) of a motor vehicle.

Each of the lamp housings 12 and 14 is shown to include a lower wall 22, an inboard wall 24, an outboard wall 26 and a rear wall 28. The rear wall 28 is stepped, including first and second portions each defining a cylindrical opening for accommodating a lamp. The walls 22-28 cooperate to define an opening for receiving a lamp assembly 30 having a lamp module 32 and a lens 33. A lip surrounds the opening for receiving the lens 33. The lamp assembly 30 may be attached with threaded fasteners (not shown).

Advantageously, the main body portion 16 of the assembly 10 is subject to a single mold tolerance. Explaining further, maximum outboard points A and B of the main body portion 16 are unitarily formed with a single injection molding procedure. In a conventional arrangement, such an assembly would include multiple components attached through a series of weldments, resulting in tolerance stack up which is eliminated by the subject invention.

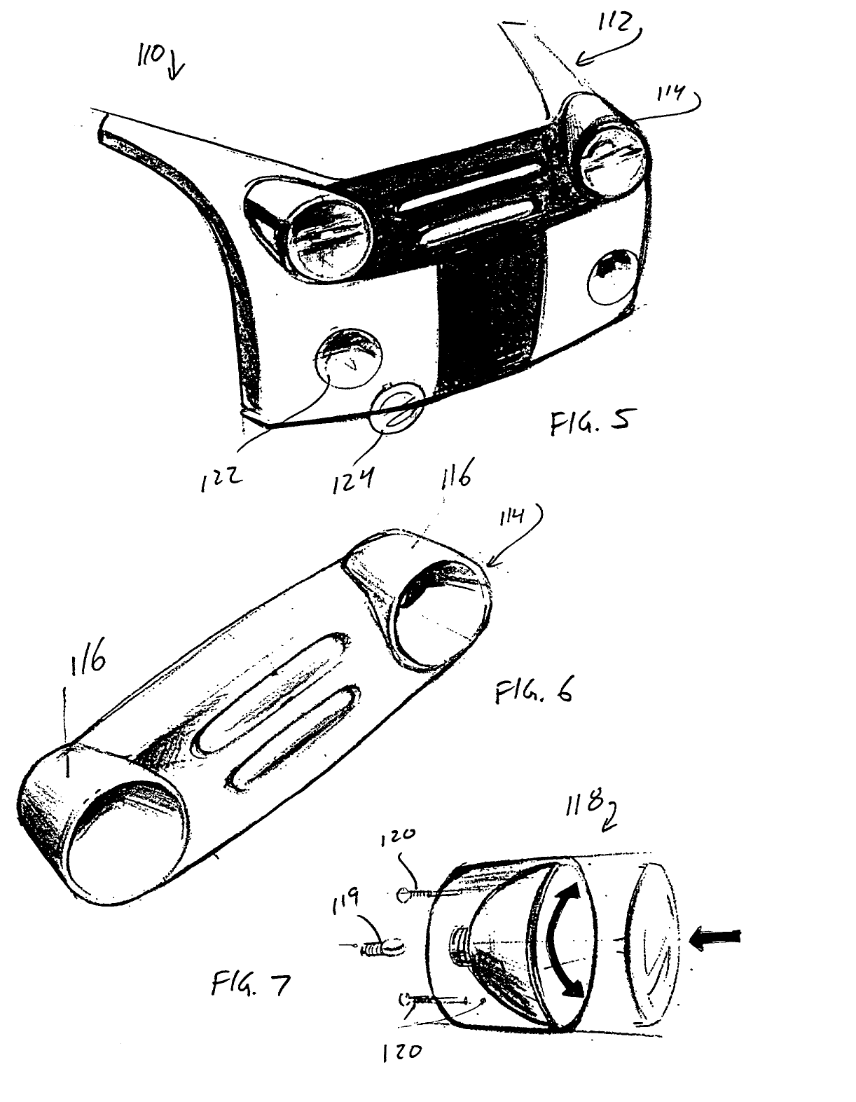

Turning now to FIGS. 5 through 7, a front fascia assembly constructed in accordance with the teachings of a second preferred embodiment of the present invention is illustrated and generally identified at reference numeral 110. The front fascia assembly is shown to include a main body portion 112 and a head lamp mounting module 114. In one application, the main body portion 112 and lamp mounting module 114 are both injection molded. As will be appreciated by those skilled in the art, the main body portion 112 and the lamp mounting module 114 may be unitarily or separately molded. The head lamp mounting module 114 includes a pair of integrated head lamp housings 116. A head lamp component assembly 118 having a bulb 119 is received directly into each of the integrated head lamp housings 116 and secured thereto with a plurality of fasteners 120. The front fascia assembly 110 is further shown to include a pair of integrated fog lamp housings 122 for receiving fog lamp component assemblies 124.

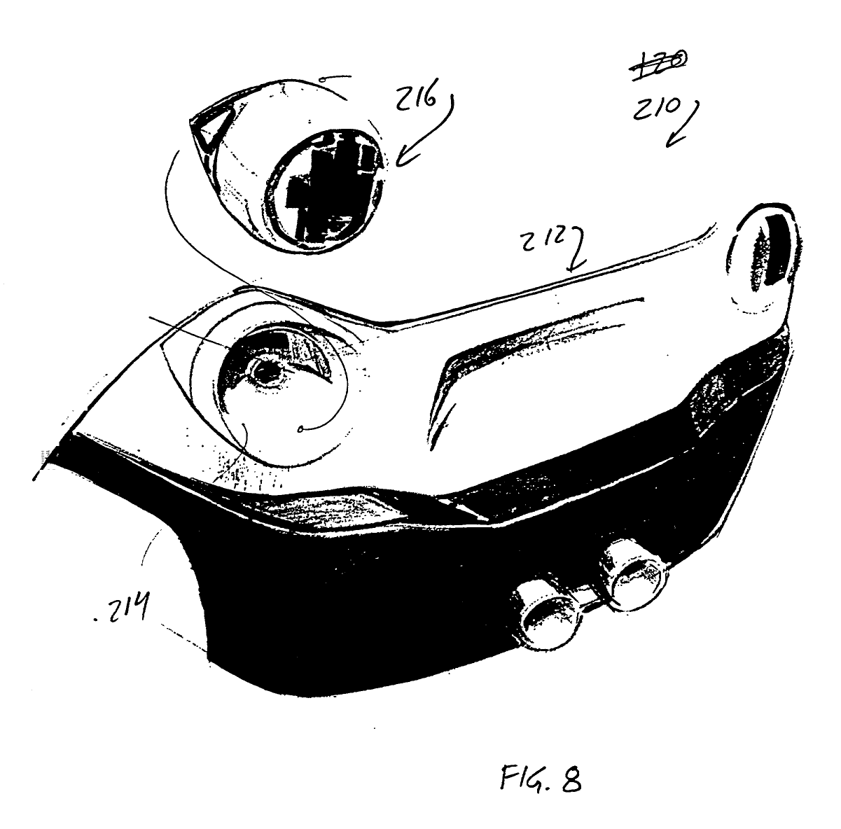

Turning finally now to FIG. 8, a rear fascia assembly constructed in accordance with the teachings of a second preferred embodiment of the present invention is illustrated and generally identified at reference numeral 210. The rear fascia assembly 210 is illustrated to include a main body portion 212 which is preferably integrally molded of plastic with an injection molding process. The main body portion 212 defines a pair of lamp housings 214. Each lamp housing 214 receives a lens assembly 216. The lens assemblies 216 are mounted directly to the main body portion 212, thereby eliminating conventional mounting brackets and unnecessary fasteners.

While not illustrated, it will be understood that accessory and ancillary equipment and controls integration functions can be incorporated to meet the needs of specific applications. While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiments illustrated by the drawings and described in the specification as the best mode presently contemplated for carrying out this invention.

What is claimed is:

1. A vehicle structural assembly comprising:
a main body portion defining first and second lamp housings, each of the lamp housings including a lower wall, an inboard wall, an outboard wall and a rear wall, the rear wall being stepped to include first and second portions each defining a cylindrical opening, the lower, inboard, outboard and rear walls defining a lamp aperture; and
first and second lamp assemblies disposed in the lamp apertures defined by the first and second lamp housings, respectively, both of the lamp assemblies including a lamp module and a lens.

2. The vehicle structural assembly of claim 1, wherein the vehicle structural assembly is a front end unit.

3. The vehicle structural assembly of claim 1, wherein the main body portion is unitarily constructed.
